(19) United States
(12) Patent Application Publication
(10) Pub. No.: US 2025/0326923 A1
(43) Pub. Date: Oct. 23, 2025

(54) POLYMER COMPOSITION COMPRISING POLYPROPYLENE AND HYDROCARBON RESIN

(71) Applicant: Borealis AG, Vienna (AT)

(72) Inventors: Jingbo Wang, Linz (AT); Markus Gahleitner, Linz (AT); Klaus Bernreitner, Linz (AT); Pauli Leskinen, Porvoo (FI); Philip Knapen, Beringen (BE)

(21) Appl. No.: 18/286,576

(22) PCT Filed: Mar. 30, 2022
(86) PCT No.: PCT/EP2022/058440

§ 371 Date: Oct. 12, 2023

(30) Foreign Application Priority Data
Apr. 30, 2021 (EP) 21171528.9

(51) Int. Cl. C08L 23/12

(52) U.S. Cl. CPC C08L 23/12; C08L 2203/30; C08L 2205/24

(57) ABSTRACT

The present invention relates to a polymer composition comprising a propylene homopolymer (A) in an amount of 70 to 99 wt. % based on the total amount of the polymer composition, wherein the polypropylene homopolymer (A) has a melt flow rate, MFR₂ (230° C./2.16 kg), as measured according to ISO 1133 in the range of 30 to 250 g/10 min, a content of 2,1 and 3,1 regio-defects of 0.0 to 1.0 mol % as measured by ¹³C NMR, a pentad isotacticity (mmmm) in the range of 90.0 to 99.9% as measured by ¹³C NMR, and a molecular weight distribution, MWD, in the range of 2.0 to 15.0; and a hydrocarbon resin (B) in an amount of from 1 to 30 wt. % based on the total amount of the polymer composition; wherein the polymer composition has a melt flow rate, MFR₂ (230° C./2.16 kg), as measured according to ISO 1133 in the range of 30 to 250 g/10 min. The invention also relates to a process for producing the polymer composition, the use of the polymer composition for injection moulding, the use of the polymer composition for producing packaging articles and an article produced from the polymer composition.

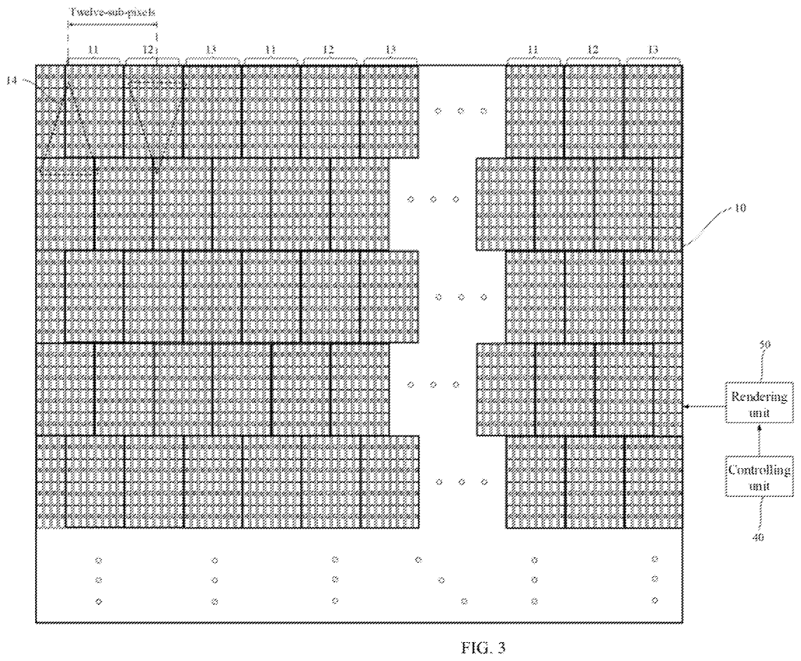

The present invention relates to a polymer composition comprising a propylene homopolymer and a hydrocarbon resin, a process for producing the polymer composition, the use of the polymer composition for injection moulding and an article produced from the polymer composition.

Polymers are widely used in daily life, including polymers such as polypropylene (PP), polyethylene (PE), polystyrene (PS) and the like. While the convenience of plastic products is enjoyed, a lot of waste is created. Too much diversity of materials will lead to a mixture of plastic waste, creating troubles for reuse and recycling. This generates the need to find sustainable solutions.

Polystyrene is widely used in thermoforming (TF) for cups and trays; however, it is known that PS is not miscible with PP and PE. Therefore, replacing PS with PP to reduce the diversity of plastic materials in particular in packaging seems necessary. Apart of that, the styrene monomer also causes issues regarding health, safety and environment (HSE). These aspects make the replacement of PS by other materials, especially PP, which is more common and has established recycling streams, desirable. However, replacing PS is a challenging task since distinctive differences between PP and PS exist. PS is glassy resp. amorphous at application temperature and, therefore, it has a high stiffness, excellent optics, but is also rather brittle. This make PS difficult for Inter-material replacement by using PP. However, several attempts to replace PS with PP have been made.

In packaging, in particular thin-wall packaging, high stiffness and good processability is required. Besides, frequently also high transparency is relevant.

Good processability is achieved i.a. through good flowability. In various manufacturing methods of articles, such as injection moulding processes, good processability allows the production of articles having low wall thicknesses and/or long flow paths in the mould. Good processability is required to ensure short production cycles or uniform filling of the moulds. This is especially important in the case of multi-cavity-tools, complex tool design or long flow path, as e.g. given in thin-walled articles. The mechanical properties are also critical in particular with respect to thin-walled articles. Particularly, in the field of containers there is a need to have a material sufficiently stiff to be stacked. In addition to that, good stiffness of the material is also needed for reducing wall-thickness of the final articles, thereby saving raw material, while maintaining impact properties at the same time. At the same time, it is a constant desire to provide materials with low haze and, hence, better see-through-properties on the content of the article.

Therefore, there is a constant need for polymeric materials allowing the reduction of diversity in plastic materials, in particular avoidance of PS, and providing a good balance of the conflicting requirements of high stiffness and good processability, along with good optical performance, such as good haze.

It has been found that the combination of a polypropylene homopolymer with hydrocarbon (HC) resin gives the right properties.

### PRIOR ART

EP 2829556 B1 relates to a process for producing a multimodal polypropylene homopolymer using a single site catalyst in a multistage polymerization process. By using a modified catalyst, a gas phase step with very high activity can be obtained. This leads not only to a higher overall productivity of the process, but also to an achievable range of polymer properties: for example, a higher gas phase split enables the production of polypropylenes with broader molecular weight distribution. Further, an increase in melt temperature Tm is achieved.

WO 2016/079111 A1 discloses non-phthalate Ziegler-Natta-Catalyst based high flow polypropylene homopolymers with high meso sequence length. New injection moulded articles for medical applications are disclosed. The polymer has an intermediate crystallization speed and low shrinkage.

EP 3184449 B1 claims non-phthalate Ziegler-Natta-Catalyst based nucleated polypropylene homopolymers or minirandom copolymers for Injection moulded articles with Improved HDT and haze.

EP 0217388 B1 relates to a transparent stretch oriented polymer film, comprising a base layer of a propylene polymer containing a low molecular weight hydrocarbon resin in an amount from about 10 to 40% by weight, calculated on the total weight of said base layer; and at least one polyolefinic top layer situated on said base layer and containing a polydialkylsiloxane in an amount of about 0.3 to 1.5% by weight calculated on total weight of said cover layer, wherein said base layer has a modulus of elasticity of not less than about 3,000 N/mm@2 as measured in both directions of orientation.

EP 0515969 A1 relates to biaxially oriented opaque multilayer sealable polypropylene films with hydrocarbon resins in one or more layers.

There is a constant need in the industry to provide polymer compositions in particular comprising polypropylene homopolymers showing good processability combined with good stiffness and good optical behaviour such as haze.

Hence, it is an object of the present invention to provide a polymer composition comprising a polypropylene with a balance of good processability, and good stiffness along with good transparency.

### OBJECT OF THE INVENTION

So the present inventors have sought to provide a polymer composition comprising a polypropylene homopolymer, whereby the composition can be easily processed, shows good mechanical and optical behaviour in the sense of higher tensile modulus und elongation at break, and good optical properties or in the sense of better ratios of stiffness to haze performance. It is a further object of the present invention to provide articles with an improved balance of said properties.

The present inventors have now surprisingly identified a polymer composition comprising, preferably consisting of,
a propylene homopolymer (A) in an amount of 70 to 99 wt. % based on the total amount of the polymer composition, wherein the polypropylene homopolymer (A) has
   a melt flow rate, MFR₂ (230° C./2.16 kg), as measured according to ISO 1133, in the range of 30 to 250 g/10 min.
   a content of 2,1 and 3,1 regio-defects of 0.0 to 1.0 mol % as measured by ¹³C NMR,
   a pentad isotacticity (mmmm) in the range of 90.0 to 99.9%, preferably in the range of 93.0 to 99.8% as measured by ¹³C NMR, and
   a molecular weight distribution, MWD, in the range of 2.0 to 15.0; and
a hydrocarbon resin (B) in an amount of from 1 to 30 wt. % based on the total amount of the polymer composition;
wherein the polymer composition has a melt flow rate, MFR₂ (230° C./2.16 kg), as measured according to ISO 1133, in the range of 30 to 250 g/10 min.

In a special embodiment, the invention relates to a process for producing the inventive polymer composition, wherein the propylene homopolymer has been obtained by polymerizing propylene in the presence of a single-site catalyst (SSC).

In a further special embodiment, the invention relates to the use of the Inventive polymer composition for injection moulding.

In another special embodiment, the invention relates to the use of the inventive polymer for producing packaging articles.

The present invention in a further special embodiment deals with an article produced from the inventive polymer composition.

### DETAILED DESCRIPTION

The polypropylene homopolymer according to the present invention relates to a polypropylene that consists substantially. i.e. of at least 99.0 wt. %, more preferably of at least 99.3 wt. %, still more preferably of at least 99.6 wt. %, like of at least 99.8 wt. % or at least 99.9 wt. %, of propylene units. In another embodiment, only propylene units are detectable, i.e. only propylene has been polymerized.

Preferably, the polypropylene homopolymer (A) has a melt flow rate, MFR₂ (230° C./2.16 kg), as measured according to ISO 1133, in the range of 40 to 200 g/10 min, and more preferably in the range of 50 to 140 g/10 min.

Equally preferably, the polypropylene homopolymer (A) has a melting temperature, Tₘ, in the range of 150 to 170° C., more preferably in the range of 152 to 164° C.

It is further preferred that the polypropylene homopolymer (A) has a content of 2,1 and 3,1 regio-defects in the range of 0.1 to 0.9 mol %, more preferably in the range of 0.2 to 0.8 mol % as measured by ¹³C NMR.

In another preferred embodiment, the polypropylene homopolymer has a molecular weight distribution. MWD, in the range of 3.0 to 7.5.

The polypropylene homopolymer in accordance with the present Invention may be unimodal or multimodal including bimodal with respect to molecular weight distribution.

Even further, the polypropylene homopolymer (A) has a flexural modulus in the range of 1400 to 2500 MPa.

According to a preferred embodiment, the polypropylene homopolymer (A) has a melting temperature, Tₘ, in the range of 150 to 170° C., preferably in the range of 152 to 164° C.; and/or a content of 2,1 and 3.1 regio-defects in the range of 0.1 to 0.9 mol %, more preferably in the range of 0.2 to 0.8 mol %; and/or a molecular weight distribution, MWD, in the range of 3.0 to 7.5; and/or a flexural modulus in the range of 1400 to 2500 MPa.

A hydrocarbon resin, especially a hydrogenated hydrocarbon resin, is a thermoplastic resin prepared from a high-grade unsaturated hydrocarbon contained in thermal pyrolysis oil such as naphtha or the like in petrochemical plants, and has excellent resistance to heat and ultraviolet (UV) rays and may be adhesive. Hydrocarbon resins are made from petroleum based feedstocks either aliphatic (C5), aromatic (C9), DCPD (dicyclopentadiene), or mixtures of these. Typically, they are low molecular oligomers and are used as tackifiers in the adhesive industry. Suitable type of materials and production processes are described in the literature, e.g. M. J. Zouriaan-Mehr & H. Omidian, Journal of Macromolecular Science, Part C: Polymer Reviews, Volume 40, 2000, Issue 1, p. 23-49.

Preferably, the hydrocarbon resin (B) has a softening point, as measured according to JIS K2207, in the range of 90 to 160° C., preferably in the range of 100 to 150° C. and more preferably in the range of 125 to 145° C.

Further preferred, the hydrocarbon resin (B) has an average molecular weight, Mn, in the range of 600 to 1000 g/mol, preferably in the range of 660 to 980 g/mol and more preferably in the range of 800 to 950 g/mol.

Preferably the hydrocarbon resin (B) has a density, as measured according to JIS K0061, in the range of 1.01 to 1.07 g/cm³ (at 20° C.), preferably in the range of 1.02 to 1.06 g/cm³ (at 20° C.), and more preferably in the range of 1.03 to 1.05 g/cm³ (at 20° C.).

Even further preferred the hydrocarbon resin (B) has a bromine number, as measured according to JIS K2605, in the range of 1.0 to 7.0 g/100 g, preferably in the range of 1.5 to 6.0 g/100 g and more preferably in the range of 2.0 to 3.0 g/100 g.

Preferably the hydrocarbon resin (B) has an aromatic content in the range of 0.0 to 10%, preferably in the range of 0.5 to 7.5% and more preferably in the range of 1.0 to 5.0%.

In a preferred embodiment the hydrocarbon resin (B) has a softening point, as measured according to JIS K2207, in the range of 90 to 160° C., preferably in the range of 100 to 150° C. and more preferably in the range of 125 to 145° C.; and/or an average molecular weight, Mn, in the range of 600 to 1000 g/mol, preferably in the range of 660 to 980 g/mol and more preferably in the range of 800 to 950 g/mol; and/or a density, as measured according to JIS K0061, in the range of 1.01 to 1.07 g/cm³ (at 20° C.), preferably in the range of 1.02 to 1.06 g/cm³ (at 20° C.), and more preferably in the range of 1.03 to 1.05 g/cm³ (at 20° C.); and/or has a bromine number, as measured according to JIS K2605, in the range of 1.0 to 7.0 g/100 g, preferably in the range of 1.5 to 6.0 g/100 g and more preferably in the range of 2.0 to 3.0 g/100 g; and/or an aromatic content in the range of 0.0 to 10%, preferably in the range of 0.5 to 7.5% and more preferably in the range of 1.0 to 5.0%.

According to another preferred embodiment, the hydrocarbon resin (B) is a at least partially hydrogenated petroleum resin, and preferably a fully hydrogenated resin. Such kind of resins are commercially available. Suitable resins are fully hydrogenated aliphatic resins such as I-MARV e.g. such as I-MARV P140, P-100, P-125 (Idemitsu Chemicals Europe Plc., Germany) and Eastotac (Eastman Chemical Company). Fully hydrogenated aromatic resins having a saturated cyclo-aliphatic structure are e.g. Plastolyn™ R1140 (Eastman Chemical Company).

In a fully hydrogenated hydrocarbon resin there is almost no, preferably no unsaturation observed by any known method.

Partially hydrogenated petroleum resins can be characterized by their bromine value, determined according to ASTM D1159. Preferably the bromine value of the partially hydrogenated petroleum resins suitable in the present invention, is at most 50, preferably at most 30, more preferably at most 15 and even more preferably at most 10.

In a preferred embodiment, the propylene homopolymer (A) is present in the polymer composition in an amount of 73 to 99 wt. %, preferably of 78 to 98.5 wt. %, more preferably of 83 to 98 wt,%, even more preferably of 88 to 97.5 wt. % and most preferably of 90 to 97.5 wt. % based on the total amount of the composition. Equally preferably, the hydrocarbon resin (B) is present in the polymer composition in an amount of 1 to 27 wt. %, preferably of 1.5 to 22 wt %, more preferably of 2.0 to 17 wt. %, even more preferably of 2.5 to 12 wt. %, and most preferably 2.5 to 10 wt. % based on the total amount of the composition.

It is preferred that the polymer composition has a melt flow rate, MFR₂ (230′C/2.16 kg), as measured according to ISO 1133, in the range of 40 to 220 g/10 min, more preferably in the range of 50 to 200 g/10 min.

It is further preferred that the polymer composition has a tensile modulus, measured according to ISO 527-2 (cross head speed=1 mm/min; 23° C.) using Injection moulded specimens as described in EN ISO 1873-2 (dog bone shape, 4 mm thickness), in the range of 1500 to 3000 MPa, preferably in the range of 1600 to 2700 MPa and more preferably in the range of 1700 to 2400 MPa.

It is even further preferred that the polymer composition has a tensile strength, measured according to ISO 527-2 (cross head speed=1 mm/min; 23° C.) using injection moulded specimens as described in EN ISO 1873-2 (dog bone shape, 4 mm thickness), In the range of 25 to 45 MPa, preferably in the range of 27 to 42 MPa and more preferably in the range of 28 to 40 MPa.

It is also further preferred that the polymer composition has an elongation at break, measured according to ISO 527-2 (cross head speed=1 mm/min; 23° C.) using Injection moulded specimens as described in EN ISO 1873-2 (dog bone shape, 4 mm thickness), of 15% or less, preferably of 10% or less, more preferably in the range of 0.5 to 8%.

It is also preferred that the polymer composition has a crystallization temperature, T_{c}, of equal or below 135° C., preferably of equal or below 129° C. and more preferably in the range of 105 to 129° C.

It is equally preferred that the polymer composition has a melting temperature, Tₘ, in the range of 140 to 180° C., preferably in the range of 145 to 175° C. and more preferably in the range of 150° C. to 170° C.

According to a specifically preferred embodiment, the polymer composition has a melting temperature, Tₘ, in the range of 140 to 180° C., preferably in the range of 145 to 175° C. and more preferably in the range of 150° C. to 170° C.; and/or a tensile modulus, measured according to ISO 527-2 (cross head speed=1 mm/min; 23° C.) using injection moulded specimens as described in EN ISO 1873-2 (dog bone shape, 4 mm thickness), In the range of 1500 to 3000 MPa, preferably in the range of 1600 to 2700 MPa and more preferably in the range of 1700 to 2400 MPa; and/or an elongation at break, measured according to ISO 527-2 (cross head speed=1 mm/min; 23′C) using injection moulded specimens as described in EN ISO 1873-2 (dog bone shape, 4 mm thickness), of 15% or less, preferably of 10% or less, more preferably in the range of 0.5 to 8%; and/or a crystallization temperature, T_{c}, of equal or below 135° C., preferably of equal or below 129° C. and more preferably in the range of 105 to 129° C.; and/or a tensile strength, measured according to ISO 527-2 (cross head speed=1 mm/min; 23′C) using injection moulded specimens as described in EN ISO 1873-2 (dog bone shape, 4 mm thickness), in the range of 25 to 45 MPa, preferably in the range of 27 to 42 MPa and more preferably in the range of 28 to 40 MPa.

It is preferred that the polymer composition the polymer composition has a haze (1 mm) when measured on 1 mm plaques of 65% or below, preferably in the range of 5 to 65%.

Specifically preferred is a polymer composition which is characterized by fulfilling any two of the following requirements:
a) tensile modulus, measured according to ISO 527-2 (cross head speed=1 mm/min; 23′C) using injection moulded specimens as described in EN ISO 1873-2 (dog bone shape, 4 mm thickness), of at least 1500 MPa; or
b) elongation at break, measured according to ISO 527-2 (cross head speed=1 mm/min; 23° C.) using injection moulded specimens as described in EN ISO 1873-2 (dog bone shape, 4 mm thickness), of 15% or less: or
c) haze (1 mm), when measured on 1 mm plaques, of 65% or below; or
d) melt flow rate, MFR2 (230° C./2.16 kg), as measured according to ISO 1133, in the range of 40 to 220 g/10 min.

Further preferred the polymer composition has a
a) haze (1 mm), when measured on 1 mm plaques, of 65% or below, preferably in the range of 5 to 65%; and
b) tensile modulus, measured according to ISO 527-2 (cross head speed=1 mm/min; 23° C.) using injection moulded specimens as described in EN ISO 1873-2 (dog bone shape, 4 mm thickness), in the range of 1500 to 3000 MPa, preferably in the range of 1600 to 2700 MPa and more preferably in the range of 1700 to 2400 MPa; and/or
c) elongation at break, measured according to ISO 527-2 (cross head speed=1 mm/min; 23° C.) using injection moulded specimens as described in EN ISO 1873-2 (dog bone shape, 4 mm thickness), of 15% or less, preferably of 10% or less, more preferably in the range of 0.5 to 8%.

In a specifically preferred embodiment, the polypropylene homopolymer (A) is produced in the presence of a single-site catalyst (SSC), wherein the polypropylene homopolymer (A) has
a melt flow rate, MFR₂ (230° C./2.16 kg), as measured according to ISO 1133, in the range of 40 to 200 g/10 min, preferably in the range of 50 to 140 g/10 min; and/or
a content of 2,1 and 3,1 regio-defects in the range of 0.1 to 0.9 mol %, preferably in the range of 0.2 to 0.8 mol % and more preferably in the range of 0.30 to 0.65 mol % as measured by ¹³C NMR; and/or
a pentad isotacticity (mmmm) in the range of 98.0 to 99.8% as measured by ¹³C NMR; and/or
a molecular weight distribution, MWD, in the range of 2.5 to 4.0, and/or
a melting temperature, Tₘ, in the range of 152 to 158° C.

In a preferred embodiment, the polymer composition comprises a nucleating agent (C).

Preferably the nucleating agent (C) is an alpha-nucleating agent or clarifying agent.

The nucleating agent present in the polymer composition of the current invention can be selected from the group consisting of:
(i) salts of monocarboxylic acids and polycarboxylic acids, e.g. aluminum tert-butylbenzoate, and
(ii) dibenzylidenesorbitol (e.g. 1,3: 2,4 dlbenzylldenesorbitol) and C1-C8-alkyl-substituted dibenzylidenesorbitol derivatives, such as methyldibenzylidenesorbitol, ethyldibenzylidenesorbitol or dimethyldibenzylidenesorbitol (e.g. 1,3 2,4 di(methylbenzylldene) sorbitol), or substituted nonitol-derivatives, such as 1,2,3, -trideoxy-4, 6:5,7-bis-O-[(4-propyiphenyl)methylene]-nonitol, or and benzene-trisamides like substituted 1,3,5-benzenetrisamides as N,N′,N″-tris-tert-butyl-1,3,5-benzenetricarboxamide, N,N′,N″-tris-cyclohexyl-1,3,5-benzene-tricarboxamide and N-[3,5-bis-(2,2-dimethyl-propionylamino)-phenyl]-2,2-dimethyl-propionamide; wherein 1,3 2,4 di(methylbenzylidene) sorbitol is preferred, and
(iii) salts of diesters of phosphoric acid, e.g. aluminium-hydroxy-bis[2,2′-methylene-bis(4,6-di-t-butylphenyl)phosphate], and hydroxybis (2,4,8,10-tetra-tert-butyl-6-hydroxy-12Hdibenzo(d,g)(1,3,2) dioxaphosphocin 6-oxidato) aluminium, and
(iv) poly(vinyt-cyclohexane) or poly(vinyl-cyclopentane).

The poly(vinyl-cyclohexane) or poly(vinyl-cyclopentane) nucleating agents are polymeric nucleating agents. Such polymeric nucleating agents can be Incorporated by the so called BNT-technology (i.e. in-reactor nucleation) which is described e.g. In patent literature, such as in WO 2016/055361.

It is envisaged within the present invention that also mixtures of alpha-nucleating agents can be used.

According to a preferred embodiment, the polymer composition comprises a nucleating agent (C) wherein the nucleating agent (C) is present in an amount of 0.00001 to 1 wt. %, preferably of 0.0001 to 0.75 wt. %, and more preferably of 0.001 to 0.5 wt. %.

The nucleated polymer composition of the present invention is characterized by a pronounced balance of stiffness to optical properties, expressed in the ratio of Tensile Modulus to Haze (TM/Haze).

This TM/Haze ratio can be at least 150 MPa/% or higher, such as at least 155 MPa/%; 200 MPa/%; 250 MPa/%; 275 MPa/% or 300 MPa/%.

Especially preferred are TM/Haze ratios of 300 MPa/% or higher, such as 325 MPa/%, 335 MPa/% or 345 MPa/% or above.

It is however envisaged in the present invention, that the inventive polymer composition may comprise further ingredients, such as additives (stabilisers, lubricants, colorants) or polymeric modifiers.

### Polymerization Process

The propylene homopolymer of the present invention can be produced by any known polymerization process, regardless whether these are single-stage or multi-stage processes, such as slurry or gas phase processes.

In case of multistage processes a preferred process is a “loop-gas phase”-process, such as developed by Borealis A/S, Denmark (known as BORSTAR® technology) is described e.g. in patent literature, such as in EP 0 887 379, WO 92/12182 WO 2004/000899, WO 2004/111095, WO 99/24478, WO 99/24479, WO 00/68315, WO2015/082379 or in WO2015/011134.

A further suitable slurry-gas phase process is the Spheripol process of LyondellBasell Industries.

### Catalyst

Possible catalysts for being used in the production of the polypropylene homopolymer are described herein and in WO 2019/179959 and WO 2017/216093.

The propylene homopolymer can been obtained by polymerizing propylene in the presence of a single-site catalyst (SSC) or a Ziegler-Natta catalyst (ZNC).

### Singla-Site Catalyst

A single site catalyst for being used in the production of the polypropylene composition is described herein and in WO 2019/179959, which is incorporated by reference herewith.

The used metallocene catalyst complexes are of formula (1):

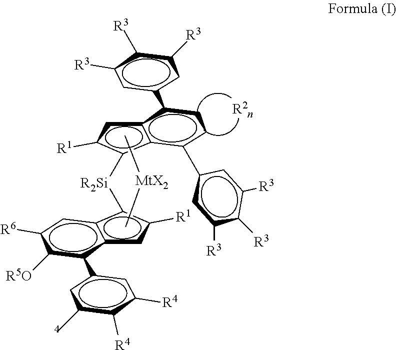

In a complex of formula (1) it is preferred if Mt is Zr or Hf, preferably Zr; each X is a sigma ligand. Most preferably, each X is independently a hydrogen atom, a halogen atom, C₁₋₆ alkoxy group or an R′ group, where R′ is a C₁₋₆ alkyl, phenyl or benzyl group. Most preferably, X is chlorine, benzyl or a methyl group. Preferably, both X groups are the same. The most preferred options are two chlorides, two methyl or two benzyl groups, especially two chlorides.

In the formula —SiR₂—, each R is independently a C₁-C₂₀-hydrocarbyl, C₆-C₂₀-aryl, C₇-C₂₀-arylalkyl or C₇-C₂₀-alkyfaryl. The term C₁₋₂₀ hydrocarbyl group therefore includes C₁₋₂₀ alkyl, C₂₋₂₀ alkenyl, C₂₋₂₀ alkynyl, C₃₋₂₀ cycloalkyl, C₃₋₂₀ cycloalkenyl, C₆₋₂₀ aryl groups, C₇₋₂₀ alkylaryl groups or C₇₋₂₀ arylalkyl groups or of course mixtures of these groups such as cycloalkyl substituted by alkyl. Unless otherwise stated, preferred C₁₋₂₀ hydrocarbyl groups are C₁₋₂₀ alkyl, C₄₋₂₀ cycloalkyl, C₅₋₂₀ cycloalkyl-alkyl groups, C₇₋₂₀ alkylaryl groups, C₇₋₂₀ arylalkyl groups or C₆₋₂₀ aryl groups.

Preferably, both R groups are the same. It is preferred if R is a C₁-C₁₀-hydrocarbyl or C₆-C₁₀-aryl group, such as methyl, ethyl, propyl, isopropyl, tert-butyl, Isobutyl. C₅₋₆-cycloalkyl, cyclohexylmethyl, phenyl or benzyl, more preferably both R are a C₁-C₆-alkyl, C₃₋₈ cycloalkyl or C₆-aryl group, such as a C₁-C₄-alkyl, C₅₋₆ cycloalkyl or C₆-aryl group and most preferably both R are methyl or one is methyl and another cyclohexyl. Most preferably the bridge is —Si(CH₃)₂—.

Each R¹ independently are the same or can be different and are a CH₂—R⁷ group, with R⁷ being H or linear or branched C₁₋₆-alkyl group, like methyl, ethyl, n-propyl, i-propyl, n-butyi, i-butyl, sec-butyl and tert-butyl or C₃₋₈ cycloalkyl group (e.g. cyclohexyl), C₆₋₁₀ aryl group (pref phenyl).

Preferably, both R¹ are the same and are a CH₂—R⁷ group, with R⁷ being H or linear or branched C₁-C4-alkyl group, more preferably, both R¹ are the same and are a CH₂—R⁷ group, with R⁷ being H or linear or branched C₁-C₃-alkyl group. Most preferably, both R¹ are both methyl. Each R² is Independently a —CH=, —CY=, —CH₂—, —CHY— or —CY₂— group, wherein Y is a C₁₋₁₀ hydrocarbyi group, preferably a C₁₋₄ hydrocarbyl group and where n is 2-6, preferably 3-4.

Each substituent R³ and R⁴ are independently the same or can be different and are hydrogen, a linear or branched C₁-C₆-alkyl group, an OY group or a C₇₋₂₀ arylalkyl, C₇₋₂₀ alkylaryl group or C₆₋₂₀ aryl group, preferably hydrogen, a linear or branched C₁-C₆-alkyl group or C₆₋₂₀ aryl groups, and optionally two adjacent R³ or R⁴ groups can be part of a ring including the phenyl carbons to which they are bonded. More preferably, R³ and R⁴ are hydrogen or a linear or branched C₁-C₄ alkyl group or a OY-group, wherein Y is a is a C₁₋₄ hydrocarbyl group. Even more preferably, each R³ and R⁴ are Independently hydrogen, methyl, ethyl, isopropyl, tart-butyl or methoxy, especially hydrogen, methyl or tert-butyl, whereby at least one R³ per phenyl group and at least one R⁴ is not hydrogen.

Thus, preferably one or two R³ per phenyl group are not hydrogen, more preferably on both phenyl groups the R³ are the same, like 3′,5′-di-methyl or 4′-tert-butyl for both phenyl groups. For the indenyl moiety preferably one or two R′ on the phenyl group are not hydrogen, more preferably two R⁴ are not hydrogen and most preferably these two R⁴ are the same like 3′,5′-di-methyl or 3′,5′-di-tert-butyl.

R⁵ is a linear or branched C₁-C₆-alkyl group such as methyl, ethyl, n-propyl, i-propyl, n-butyl, i-butyl, sec-butyl and tert-butyl, C₇₋₂₀ arylalkyl, C₇₋₂₀ alkylaryl group or C₆-C₂₀ aryl group. R⁵ is a preferably a linear or branched C₁-C₆ alkyl group or C₆₋₂₀ aryl group, more preferably a linear C₁-C₄ alkyl group, even more preferably a C₁-C₂ alkyl group and most preferably methyl.

R is a C(R⁸)₃ group, with R⁸ being a linear or branched C₁-C₆ alkyl group. Each R is independently a C₁-C₂₀-hydrocarbyl, C₆-C₂₀-aryl, C₇-C₂₀-arylalkyl or C₇-C₂₀-alkylaryl. Preferably each R⁸ are the same or different with R⁸ being a linear or branched C₁-C₄-alkyl group, more preferably with R₈ being the same and being a C₁-C₂-alkyl group. Most preferably, all R⁸ groups are methyl.

Specific metallocene catalyst complexes include:
rac-anti-dimethylsilanediyl[2-methyl-4,8-bis-(4′-tert-butylphenyl)-1,5,6,7-tetrahydro-s-indacen-1-yl][2-methyl-4-(3′,5′-dimethyl-phenyl)-5-methoxy-8-tert-butylinden-1-yl) zirconium dichloride (MC-1);
rac-anti-dimethylsilanediyl[2-methyl-4,8-bis-(3′,5′-dimethylphenyl)-1,5,6,7-tetrahydro-s-indacen-1-yl)] [2-methyl-4-(3′,5′-dimethylphenyl)-5-methoxy-6-tert-butylinden-1-yl]zirconium dichloride (MC-2);
rac-anti-dimethylsilanediyl[2-methy-4,8-bis-(3′,5′-dimethylphenyl)-1,5,6,7-tetrahydro-s-indacen-1-yl][2-methyl-4-(3′,5′-ditert-butyl-phenyl)-5-methoxy-6-tert-butylinden-1-yl] zirconium dichloride (MC-3) or their corresponding zirconium dimethyl analogues.

| | |
|---|---|
| 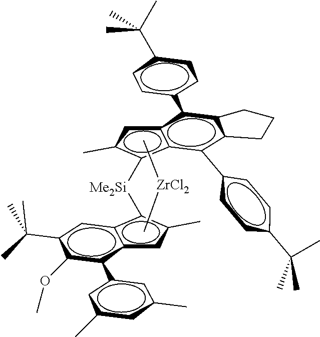 | MC-1 |
| 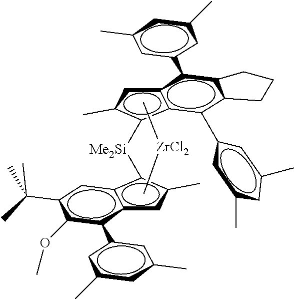 | MC-2 |
| 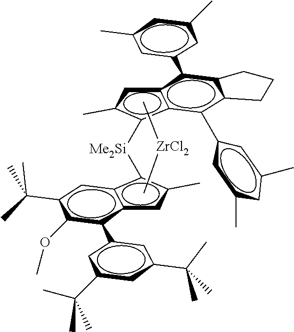 | MC-3 |

For the avoidance of doubt, any narrower definition of a substituent offered above can be combined with any other broad or narrowed definition of any other substituent. Throughout the disclosure above, where a narrower definition of a substituent is presented, that narrower definition is deemed disclosed in conjunction with all broader and narrower definitions of other substituents in the application.

### Ligands

The ligands required to form the metallocene catalysts can be synthesized by any process and the skilled organic chemist would be able to devise various synthetic protocols for the manufacture of the necessary ligand materials. WO 2007/116034 discloses the necessary chemistry and is herein incorporated by reference. Synthetic protocols can also generally be found in WO 2002/02576, WO 2011/135004. WO 2012/084961, WO2012/001052, WO 2011/076780, WO 2015/158790 and WO 2019/179959. The examples section also provides the skilled person with sufficient direction.

### Cocatalyst

To form an active catalytic species it is normally necessary to employ a cocatalyst as is well known in the art. Here a cocatalyst system comprising a boron containing cocatalyst and/or an aluminoxane cocatalyst is used in combination with the above defined metallocene catalyst complex.

The aluminoxane cocatalyst can be one of formula (X):

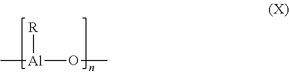

where n is usually from 6 to 20 and R has the meaning below.

Aluminoxanes are formed on partial hydrolysis of organoaluminum compounds, for example those of the formula AlR₃, AlR₂Y and Al₂R₃Y₃ where R can be, for example, C₁-C₁₀ alkyl, preferably C₁-C₅ alkyl, or C₃₋₁₀ cycloalkyl, C₇-C₁₂ arylalkyl or alkylaryl and/or phenyl or naphthyl, and where Y can be hydrogen, halogen, preferably chlorine or bromine, or C₁-C₁₀ alkoxy, preferably methoxy or ethoxy. The resulting oxygen-containing aluminoxanes are not in general pure compounds but mixtures of oligomers of the formula (X).

The preferred aluminoxane is methylaluminoxane (MAO). Since the aluminoxanes used according to the Invention as cocatalysts are not, owing to their mode of preparation, pure compounds, the molarity of aluminoxane solutions hereinafter is based on their aluminium content.

Also a boron containing cocatalyst can be used instead of the aluminoxane cocatalyst or the aluminoxane cocatalyst can be used in combination with a boron containing cocatalyst.

It will be appreciated by the skilled man that where boron based cocatalysts are employed, it is normal to pre-alkylate the complex by reaction thereof with an aluminium alkyl compound, such as TIBA. This procedure is well known and any suitable aluminium alkyl, e.g. Al(C₁₋₆-alkyl)₃ can be used. Preferred aluminium alkyl compounds are triethylaluminium, tri-Isobutylaluminium, tri-isohexylaluminium, tri-n-octylaluminium and tri-isooctylaluminium. Alternatively, when a borate cocatalyst is used, the metallocene catalyst complex is in its alkylated version, that is for example a dimethyl or dibenzyl metallocene catalyst complex can be used.

Boron based cocatalysts of interest include those of formula (Z)

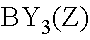

wherein Y is the same or different and is a hydrogen atom, an alkyl group of from 1 to about 20 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred examples for Y are methyl, propyl, isopropyl, isobutyl or trifluoromethyl, unsaturated groups such as aryl or haloaryl like phenyl, tolyl, benzyl groups, p-fluorophenyl, 3,5-difluorophenyl, pentachlorophenyl, pentafluorophenyl, 3,4,5-trifluorophenyl and 3,5-di(trifluoromethyl)phenyl. Preferred options are trifluoroborane, triphenylborane, tris(4-fluorophenyl)borane, tris(3,5-difiuorophenyl)borane, tris(4-fluoromethylphenyl)borane, tris(2,4,6-trifluorophenyl)borane, tris(penta-fluorophenyl)borane, tris(tolyl)borane, tris(3,5-dimethyl-phenyl)borane, tris(3,5-difluorophenyl)borane and/or tris (3,4,5-trifluorophenyl)borane. Particular preference is given to tris(pentafluorophenyl)borane.

However, it is preferred that borates are used, i.e. compounds containing a borate 3+ ion. Such ionic cocatalysts preferably contain a non-coordinating anion such as tetrakis(pentafluorophenyl)borate and tetraphenylborate. Suitable counterions are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

Preferred Ionic compounds which can be used include: trimethylammoniumtetra(phenyl)borate, tributylammoniumtetra(phenyl)borate, trimethylammoniumtetra(tolyl)borate, tributylammoniumtetra(tolyl)borate, tributylammoniumtetra(pentafluorophenyl)borate, tripropylammoniumtetra(dimethylphenyl)borate, tributylammoniumtetra(trifluoromethylphenyl)borate, tributylammoniumtetra(4-fluorophenyl)borate, N,N-dimethylcyclohexylammoniumtetrakis(pentafluorophenyl)borate, N,N-dimethylbenzylammoniumtetrakis(pentafluorophenyl)borate, N,N-dimethylaniliniumtetra(phenyl)borate, N,N-diethylaniliniumtetra(phenyl)borate, N,N-dimethylaniliniumtetrakis(pentafiluorophenyl)borate, N,N-di(propyl)ammoniumtetrakis(pentefluorophenyl)borate, di(cyclohexyl)ammoniumtetrakist(pentafluorophenyl)borate, triphenylphosphoniumtetrakis(phenyl)borate, triethylphosphoniumtetrakis(phenyl)borate, diphenylphosphoniumtetrakis(phenyl)borate, tri(methylphenyl)phosphoniumtetrakis(phenyl)borate, tri(dimethylphenyl)phosphoniumtetrakis(phenyl)borate, triphenylcarbeniumtetrakis(pentafluorophenyl)borate, or ferroceniumtetrakis(pentafluorophenyl)borate.

Preference is given to triphenylcarbeniumtetrakis(pentafluorophenyl) borate, N,N-dimethylcyclohexylammoniumtetrakis(pentafluorophenyl)borate or N,N-dimethylbenzylammoniumtetrakis(pentafluorophenyl)borate. Certain boron cocatalysts are especially preferred. Preferred borates comprise the trityl ion. Thus, the use of N,N-dimethylammonium-tetrakispentafluorophenylborate and Ph₃CB(PhF₅)₄ and analogues therefore are especially favoured.

Also preferred cocatalysts are alumoxanes, more preferably methylalumoxanes, combinations of alumoxanes with Al-alkyls, boron or borate cocatalysts and combination of alumoxanes with boron-based cocatalysts. Preferred cocatalysts are alumoxanes, most preferably methylalumoxanes.

Suitable amounts of cocatalyst will be well known to the skilled man.

The molar ratio of boron to the metal ion of the metallocene may be in the range of 0.5:1 to 10:1 mol/mol, preferably in the range of 1:1 to 10:1, especially in the range of 1:1 to 5:1 mol/mol.

The molar ratio of Al in the aluminoxane to the metal ion of the metallocene may be in the range of 1:1 to 2000:1 mol/mol, preferably in the range of 10:1 to 1000:1, and more preferably in the range of 50:1 to 500:1 mol/mol.

### Catalyst Manufacture

The metallocene catalyst complex can be used in combination with a suitable cocatalyst as a catalyst for the polymerization of propylene, e.g. In a solvent such as toluene or an aliphatic hydrocarbon, (i.e. for polymerization in solution), as it is well known in the art. Preferably, polymerization of propylene takes place in the condensed phase or in gas phase.

The catalyst of the invention can be used in supported or unsupported form. The particulate support material used is preferably an organic or inorganic material, such as silica, alumina or zirconia or a mixed oxide such as silica-alumina, in particular silica, alumina or silica-alumina.

The use of a silica support is preferred. The skilled man is aware of the procedures required to support a metallocene catalyst.

Especially preferably the support is a porous material so that the complex may be loaded into the pores of the support, e.g. using a process analogous to those described in WO 94/14856, WO 95/12622 and WO 2006/097497. The particle size is not critical but is preferably in the range of 5 to 200 μm, more preferably in the range of 20 to 80 μm. The use of these supports is routine in the art.

Alternatively, no support is used at all. Such a catalyst can be prepared in solution, for example in an aromatic solvent like toluene, by contacting the metallocene (as a solid or as a solution) with the cocatalyst, for example methylaluminoxane or a borane or a borate salt previously dissolved in an aromatic solvent, or can be prepared by sequentially adding the dissolved catalyst components to the polymerization medium.

Also no external carrier may be used but the catalyst is still presented in solid particulate form. Thus, no external support material, such as inert organic or inorganic carrier, for example silica as described above is employed.

In order to provide the catalyst in solid form but without using an external carrier, it is preferred if a liquid/liquid emulsion system is used. The process Involves forming dispersing catalyst components (i) and (ii) in a solvent, and solidifying said dispersed droplets to form solid particles.

In particular, the method Involves preparing a solution of one or more catalyst components; dispersing said solution in an solvent to form an emulsion in which said one or more catalyst components are present in the droplets of the dispersed phase; immobilizing the catalyst components in the dispersed droplets, in the absence of an external particulate porous support, to form solid particles comprising the said catalyst, and optionally recovering said particles.

This process enables the manufacture of active catalyst particles with improved morphology, e.g. with a predetermined spherical shape, surface properties and particle size and without using any added external porous support material, such as an inorganic oxide, e.g. silica. By the term “preparing a solution of one or more catalyst components” is meant that the catalyst forming compounds may be combined in one solution, which is dispersed to the immiscible solvent, or, alternatively, at least two separate catalyst solutions for each part of the catalyst forming compounds may be prepared, which are then dispersed successively to the solvent.

Full disclosure of the necessary process can be found in WO 03/051934, which is herein Incorporated by reference.

### Ziegler-Natta-Catalyst

Another catalyst for being used in the production of the polypropylene composition is described herein and WO 2017/216093, which is also Incorporated by reference herewith.

The catalyst is a solid Ziegler-Natta catalyst (ZN-C), which comprises compounds (TC) of a transition metal of Group 4 to 6 of IUPAC, like titanium, a Group 2 metal compound (MC), like a magnesium, and an internal donor (ID) being a phthalate or preferably a non-phthalic compound, preferably a non-phthalic acid ester, still more preferably being a diester of non-phthalic dicarboxylic acids as described in more detail below. Thus, the catalyst is in a preferred embodiment fully free of undesired phthalic compounds. Further, the solid catalyst is free of any external support material, like silica or MgCl₂, but the catalyst is self-supported.

The Ziegler-Natta catalyst (ZN-C) can be further defined by the way as obtained. Accordingly, the Ziegler-Natta catalyst (ZN-C) is preferably obtained by a process comprising the steps of a)
a₁) providing a solution of at least a Group 2 metal alkoxy compound (Ax) being the reaction product of a Group 2 metal compound (MC) and a monohydric alcohol (A) comprising in addition to the hydroxyl moiety at least one ether moiety optionally in an organic liquid reaction medium; or
a₂) a solution of at least a Group 2 metal alkoxy compound (Ax′) being the reaction product of a Group 2 metal compound (MC) and an alcohol mixture of the monohydric alcohol (A) and a monohydric alcohol (B) of formula ROH, optionally in an organic liquid reaction medium; or
a₃) providing a solution of a mixture of the Group 2 alkoxy compound (Ax) and a Group 2 metal alkoxy compound (Bx) being the reaction product of a Group 2 metal compound (MC) and the monohydric alcohol (B), optionally in an organic liquid reaction medium; or
a₄) providing a solution of Group 2 alkoxide of formula M(OR₁)ₙ(OR₂)ₘX₂₋ₙ₋ₘ or mixture of Group 2 alkoxides M(OR₁)_{n′}X_{2-n′} and M(OR₂)_{m′}X_{2-m′}, where M is Group 2 metal, X is halogen, R₁ and R₂ are different alkyl groups of C₂ to C₁₆ carbon atoms, and 0≤n<2, 0≤m<2 and n+m+(2-n-m)=2, provided that both n and m≠0, 0<n′≤2 and 0<m′≤2; and
b) adding said solution from step a) to at least one compound (TC) of a transition metal of Group 4 to 6 and
c) obtaining the solid catalyst component particles,
and adding an internal electron donor (ID), preferably a non-phthalic internal donor (ID), at any step prior to step c).

The internal donor (ID) or precursor thereof is thus added preferably to the solution of step a) or to the transition metal compound before adding the solution of step a).

According to the procedure above the Ziegler-Natta catalyst (ZNC) can be obtained via precipitation method or via emulsion—solidification method depending on the physical conditions, especially temperature used in steps b) and c). Emulsion is also called in this application liquid/liquid two-phase system.

In both methods (precipitation or emulsion-solidification) the catalyst chemistry is the same.

In precipitation method combination of the solution of step a) with at least one transition metal compound (TC) in step b) is carried out and the whole reaction mixture is kept at least at 50° C. more preferably in the temperature range of 55 to 110° C., more preferably in the range of 70 to 100° C., to secure full precipitation of the catalyst component in form of a solid particles (step c).

In emulsion—solidification method in step b) the solution of step a) is typically added to the at least one transition metal compound (TC) at a lower temperature, such as from −10 to below 50° C., preferably from −5 to 30° C. During agitation of the emulsion the temperature is typically kept at −10 to below 40° C., preferably from −5 to 30° C. Droplets of the dispersed phase of the emulsion form the active catalyst composition. Solidification (step c) of the droplets is suitably carried out by heating the emulsion to a temperature of 70 to 150° C., preferably to 80 to 110° C.

The catalyst prepared by emulsion—solidification method is preferably used in the present invention.

In a preferred embodiment in step a) the solution of a₂) or a₃) are used, i.e. a solution of (Ax′) or a solution of a mixture of (Ax) and (Bx), especially the solution of a₂).

Preferably the Group 2 metal (MC) is magnesium.

The magnesium alkoxy compounds as defined above can be prepared in situ in the first step of the catalyst preparation process, step a), by reacting the magnesium compound with the alcohol(s) as described above, or said magnesium alkoxy compounds can be separately prepared magnesium alkoxy compounds or they can be even commercially available as ready magnesium alkoxy compounds and used as such in the catalyst preparation process of the invention.

Illustrative examples of alcohols (A) are glycol monoethers. Preferred alcohols (A) are C₂ to C₄ glycol monoethers, wherein the ether moieties comprise from 2 to 18 carbon atoms, preferably from 4 to 12 carbon atoms. Preferred examples are 2-(2-ethylhexyloxy)ethanol, 2-butyloxy ethanol, 2-hexyloxy ethanol and 1,3-propylene-glycol-monobutyl ether, 3-butoxy-2-propanol, with 2-(2-ethylhexyloxy)ethanol and 1,3-propylene-glycol-monobutyi ether, 3-butoxy-2-propanol being particularly preferred.

Illustrative monohydric alcohols (B) are of formula ROH, with R being straight-chain or branched C₂-C₁₆ alkyl residue, preferably C₄ to C₁₀, more preferably C6 to C₈ alkyl residue. The most preferred monohydric alcohol is 2-ethyl-I-hexanol or octanol.

Preferably a mixture of Mg alkoxy compounds (Ax) and (Bx) or mixture of alcohols (A) and (B), respectively, are used and employed in a mole ratio of Bx:Ax or B:A from 10:1 to 1:10, more preferably 6:1 to 1:6, most preferably 4.1 to 1:4.

Magnesium alkoxy compound may be a reaction product of alcohol(s), as defined above, and a magnesium compound selected from dialkyl magnesium, alkyl magnesium alkoxides, magnesium dialkoxides, alkoxy magnesium halides and alkyl magnesium halides. Further, magnesium dialkoxides, magnesium diaryloxides, magnesium aryloxyhalides, magnesium aryloxides and magnesium alkyl aryloxides can be used. Alkyl groups can be a similar or different C₁-C₂₀ alkyl, preferably C₂-C₁₀ alkyl. Typical alkyl-alkoxy magnesium compounds, when used, are ethyl magnesium butoxide, butyl magnesium pentoxide, octyl magnesium butoxide and octyl magnesium octoxide. Preferably the dialkyl magnesium are used. Most preferred dialkyl magnesium are butyl octyl magnesium or butyl ethyl magnesium.

It is also possible that magnesium compound can react in addition to the alcohol (A) and alcohol (B) also with a polyhydric alcohol (C) of formula R″ (OH)ₘ to obtain said magnesium alkoxide compounds. Preferred polyhydric alcohols, if used, are alcohols, wherein R″ is a straight-chain, cyclic or branched C₂ to C₁₀ hydrocarbon residue, and m is an integer of 2 to 6.

The magnesium alkoxy compounds of step a) are thus selected from the group consisting of magnesium dialkoxides, diaryloxy magnesium, alkyloxy magnesium halides, aryloxy magnesium halides, alkyl magnesium alkoxides, aryl magnesium alkoxides and alkyl magnesium aryloxides. In addition a mixture of magnesium dihalide and a magnesium dialkoxide can be used.

The solvents to be employed for the preparation of the present catalyst may be selected among aromatic and aliphatic straight chain, branched and cyclic hydrocarbons with 5 to 20 carbon atoms, more preferably 5 to 12 carbon atoms, or mixtures thereof. Suitable solvents include benzene, toluene, cumene, xylene, pentane, hexane, heptane, octane and nonane. Hexanes and pentanes are particular preferred.

The reaction for the preparation of the magnesium alkoxy compound may be carried out at a temperature of 40° to 70° C. Most suitable temperature is selected depending on the Mg compound and alcohol(s) used.

The transition metal compound of Group 4 to 6 is preferably a titanium compound, most preferably a titanium halide, like TiCl₆.

The internal donor (ID) used in the preparation of the catalyst used in the present invention is preferably selected from (di)esters of non-phthalic carboxylic (di)acids, 1,3-diethers, derivatives and mixtures thereof. Especially preferred donors are diesters of mono-unsaturated dicarboxylic acids, in particular esters belonging to a group comprising malonates, maleates, succinates, citraconates, glutarates, cyclohexene-1,2-dicarboxylates and benzoates, and any derivatives and/or mixtures thereof. Preferred examples are e.g. substituted maleates and citraconates, most preferably citraconates.

In emulsion method, the two phase liquid-liquid system may be formed by simple stirring and optionally adding (further) solvent(s) and additives, such as the turbulence minimizing agent (TMA) and/or the emulsifying agents and/or emulsion stabilizers, like surfactants, which are used in a manner known in the art for facilitating the formation of and/or stabilize the emulsion. Preferably, surfactants are acrylic or methacrylic polymers. Particular preferred are unbranched C₁₂ to C₂₀ (meth)acrylates such as poly(hexadecyl)-methacrylate and poly(octadecyl)-methacrylate and mixtures thereof. Turbulence minimizing agent (TMA), if used, is preferably selected from α-olefin polymers of α-olefin monomers with 6 to 20 carbon atoms, like polyoctene, polynonene, polydecene, polyundecene or polydodecene or mixtures thereof. Most preferable it is polydecene.

The solid particulate product obtained by precipitation or emulsion—solidification method may be washed at least once, preferably at least twice, most preferably at least three times with an aromatic and/or aliphatic hydrocarbons, preferably with toluene, heptane or pentane and or with TiCl₄. Washing solutions can also contain donors and/or compounds of Group 13, like trialkyl aluminum, halogenated alky aluminum compounds or alkoxy aluminum compounds. Aluminum compounds can also be added during the catalyst synthesis. The catalyst can further be dried, as by evaporation or flushing with nitrogen, or it can be slurried to an oily liquid without any drying step.

The finally obtained Ziegler-Natta catalyst is desirably in the form of particles having generally an average particle size range of 5 to 200 μm, preferably 10 to 100. Particles are compact with low porosity and have surface area below 20 g/m², more preferably below 10 g/m². Typically the amount of Ti is 1 to 6 wt. %, Mg 10 to 20 wt. % and donor 10 to 40 wt. % of the catalyst composition.

Detailed description of preparation of catalysts is disclosed in WO 2012/007430, EP 2610271, EP 2610270 and EP2610272 which are Incorporated here by reference.

The Ziegler-Natta catalyst is preferably used in association with an alkyl aluminum cocatalyst and optionally external donors.

As further component in the instant polymerization process an external donor (ED) is preferably present. Suitable external donors (ED) include certain silanes, ethers, esters, amines, ketones, heterocyclic compounds and blends of these. It is especially preferred to use a silane.

Specific examples of such silanes are dicyclopentyl-dimethoxy silane (CAS 126990-35-0), cyclohexyl(methyl) dimethoxy silane (CAS 17865-32-6), trimethoxy (1.1.2-trimethylpropyl) silane (i.e. thexyl trimethoxy silane, CAS 142877-45-0) or tert-butyl dimethoxy (methyl) silane (CAS 18293-81-7)

### Article

Preferably, the article is produced by moulding the inventive polymer composition.

The article can therefore be a “moulded article”. The term “moulded article” is intended to encompass articles that are produced by any conventional moulding technique, for example injection moulding, stretch moulding, extrusion blow moulding, compression moulding, rotomoulding or injection stretch blow moulding.

The term is not intended to encompass articles that are produced by casting or extrusion, such as extrusion blow moulding. Thus, the term is not intended to include films or sheets.

Articles produced by injection moulding, stretch moulding, or injection stretch blow moulding are preferred.

Even more preferred the article is produced by injection moulding the polymer composition according to the invention.

According to a preferred embodiment, the article is used for packaging, preferably thin wall packaging or food packaging.

In a preferred embodiment, the article has a wall thickness in the range of 0.1 to 2.5 mm, preferably in the range of 0.5 to 2.0 mm, more preferably in the range of 0.7 to 1.5 mm and most preferably in the range of 0.9 to 1.2 mm.

The articles of the current invention can be containers, such as cups, buckets, beakers, trays or parts of such articles, such as see-through-windows, lids, or the like.

The articles of the current invention are especially suitable for containing food, especially frozen food, such as Ice cream, frozen liquids, sauces, pre-cooked convenience products, and the like.

Articles of the current invention are also suitable for medical or diagnostic purposes, such as syringes, beaker, pipettes, etc.

It is however envisaged in the present invention, that the articles produced from the inventive polymer composition may comprise further ingredients, such as additives (stabilisers, lubricants, colorants) or polymeric modifiers in very minor amounts.

The present invention will now be described in further detail by the examples provided below.

### Experimental Section

### Determination Methods

Unless otherwise stated the following methods were used for determining the properties of the polymer composition or the components thereof as given in the description or in the experimental part and claims below. Unless otherwise stated, the samples used in the tests consist of the polymer composition or, respectively as specified, of the polymer component to be tested.

### Quantification of Microstructure by NMR Spectroscopy

Quantitative nuclear-magnetic resonance (NMR) spectroscopy was used to quantify the isotacticity, tacticity distribution and content of regio-defects of the polymers. Quantitative ¹³C {¹H}NMR spectra recorded in the solution-state using a Bruker Advance III 400 NMR spectrometer operating at 400.15 and 100.62 MHz for ¹H and ¹³C respectively. All spectra were recorded using a ¹³C optimised 10 mm selective excitation probehead at 125° C. using nitrogen gas for all pneumatics. Approximately 200 mg of material was dissolved in 1,2-tetrachloroethane-d₂ (TCE-d₂). This setup was chosen primarily for the high resolution needed for tacticity distribution quantification (Busico, V., Cipullo, R., Prog. Polym. Sc. 26 (2001) 443; Busico, V., Cipullo, R., Monaco, G., Vacatello, M., Segre, A L., Macromoleucles 30 (1997) 6251). Standard single-pulse excitation was employed utilising the NOE and bi-level WALTZ16 decoupling scheme {zhou07, busico07}. A total of 8192 (8 k) transients were acquired per spectra.

The tacticity distribution was quantified through integration of the methyl region between 23.6 and 19.7 ppm correcting for any sites not related to the stereo sequences of interest (Busico, V., Cipullo, R., Prog. Polym. Sci. 26 (2001) 443; Busico, V., Cipullo, R., Monaco, G., Vacatello, M., Segre, A. L., Macromoleucles 30 (1997) 6251). Characteristic signals corresponding to the presence of regio defects (Resconi, L., Cavallo, L., Fait, A., Piemontesi, F., Chem. Rev. 2000, 100, 1253) and ethylene copolymerization (Wang, W-J., Zhu, S., Macromolecules 33 (2000), 1157; Cheng, H. N., Macromolecules 17 (1984), 1950) were not observed.

The pentad tacticity distribution was determined through direct separate integration of each methyl signal from a given steric pentad followed by normalisation to the sum of methyl signals from all steric pentads. The relative content of a specific steric pentad was reported as the mole fraction or percentage of a given steric pentad xxxx with respect to all steric pentads:

[xxxx]=xxxx/(mmmm+mmmr+rmmr+mmrr+xmrx+mrmr+rrr+mrer+mrrm)
where xmrx represents the combined integral of both mmrm and rmrr as signal from these steric pentads are not commonly resolved. The pentad isotacticity was thus given by:

[mmmm]=mmmm/(mmmm+mmmr+rmmr+mmrr+xmrx+mrmr+rrrr+mrrr+mrrm)

The triad tacticity distribution was indirectly determined from the pentad tacticity distribution using the known pentad-triad necessary relationships:

$$[ mm ] = [ mmmm ] + [ mmmr ] + [ rmmr ]$$

$$[ mr ] = [ mmrr ] + [ xmrx ] + [ mrmr ]$$

$$[ rr ] = [ rrr ] + [ mrrr ] + [ mrrm ]$$

The average length of stereo sequences consisting of two or more monomer unites with like tacticity, i.e. the meso sequence length determined from the triad tacticity distribution (MSL2), was calc using the relative amounts of the mm and mr steric triads:

$$MSL 2 = 2 + 2 [ mm ] / [ mr ]$$

The average length of stereo sequences consisting of four or more monomer unites with like tacticity, i.e. the meso sequence length determined from the pentad tacticity distribution (MSL4), was calc using the relative amounts of the mmmm and mmmr steric pentads:

$$MSL 4 = 4 + 2 [ mmmm ] / [ mmmr ]$$

Klimke, K., Parkinson, M., Piel, C., Kaminsky, W., Spiess, H. W., Wilhelm, M., Macromol. Chem. Phys. 2006; 207:382.
Parkinson, M., Klimke, K., Spiess. H. W., Wilhelm, M., Macromol. Chem. Phys. 2007; 208:2128.
Pollard, M., Klimke, K., Graf, R., Spiess, H. W., Wilhelm, M., Sperber, O., Piei, C., Kaminsky, W., Macromolecules 2004; 37:813.
Filip, X., Tripon, C., Filip, C., J. Mag. Resn. 2005, 176, 239 Griffin, J. M., Tripon, C., Samoson, A., Filip, C., and Brown, S. P., Mag. Res. in Chem. 2007 45,81, S198
Castignolles, P., Graf, R., Parkinson, M., Wilhelm, M., Gaborieau, M., Polymer 50 (2009) 2373
Busico, V., Cipullo, R., Prog. Polym. Sci. 26 (2001) 443
Busico, V., Cipullo, R., Monaco, G., Vacatello, M., Segre, A. L., Macromoleucles 30 (1997) 6251
Zhou, Z., Kuemmerie, R., Qiu, X., Redwine, D., Cong, R., Taha, A., Baugh, D. Winniford, B., J. Mag. Reson. 187 (2007) 225
Busico, V., Carbonniere, P., Cipullo, R., Pellecchia, R., Sevem, J., Talarico, G., Macromol. Rapid Commun. 2007, 28, 1128
Resconi, L., Cavallo. L., Fait, A., Piemontesi, F., Chem. Rev. 2000, 100, 1253

### Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR is determined at 230° C. for polypropylene and at a loading of 2.16 kg (MFR₂).

### Molecular Weight

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-4:2003 and ASTM D 6474-99 using the following formulas:

$${M}_{n} = \frac{{\sum }_{i = 1}^{N} {A}_{i}}{\sum ( {A}_{i} / {M}_{i} )}$$

$${M}_{w} = \frac{{\sum }_{i = 1}^{N} ( {A}_{i} \times {M}_{i} )}{\sum {A}_{i}}$$

$${M}_{z} = \frac{{\sum }_{i = 1}^{N} ( {A}_{i} \times {M}_{i}^{2} )}{\sum ( {A}_{i} / {M}_{i} )}$$

where Aᵢ and Mᵢ are the chromatographic peak slice area and polyolefin molecular weight (MW).

A PolymerChar GPC instrument, equipped with infrared (IR) detector was used with 3× Olexis and 1× Olexis Guard columns from Polymer Laboratories and 1,2,4-trichlorobenzene (TCB, stabilized with 250 mg/l 2,6-Di-tert-butyl-4-methyl-phenol) as solvent at 160° C. and at a constant flow rate of 1 ml/min. 200 μL of sample solution were injected per analysis. The column set was calibrated using universal calibration (according to ISO 16014-2:2003) with at least 15 narrow MWD polystyrene (PS) standards in the range of 0.5 kg/mol to 11500 kg/mol. Mark Houwink constants used for PS, PE and PP are as described per ASTM D 6474-99. All samples were prepared by dissolving 5.0 to 9.0 mg of polymer in 8 ml (at 160° C.) of stabilized TCB (same as mobile phase) for 2.5 hours for PP or 3 hours for PE at 160 C under continuous gentle shaking in the autosampler of the GPC instrument.

### Density

Density of the polymer was measured according to ISO 1183-1:2004 (method A) on compression moulded specimen prepared according to EN ISO 1872-2(February 2007) and is given in kg/m³.

DSC analysis-Tₘ, Hₘ, T_{c}

The melting temperature (Tₘ) and melting enthalpy (Hₘ) as well as crystallization temperature (T_{c}.) are measured with a TA Instrument Q200 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C. Crystallization temperature is determined from the cooling step, while melting temperature and melting enthalpy (Hₘ) are determined from the second heating step.

### Tensile Modulus, Tensile Strength, Elongation at Break

Tensile modulus, tensile strength and elongation at break were measured according to ISO 527-2 (cross head speed=1 mm/min; 23° C.) using Injection moulded specimens as described in EN ISO 1873-2 (dog bone shape, 4 mm thickness).

### Flexural Modulus

The Flexural Modulus is determined in 3-point-bending according to ISO 178 on injection moulded specimens of 80×10×4 mm³ prepared in accordance with EN ISO 1873-2.

### Haze

Haze is determined according to ASTM D1003-00 on 60×60×1 mm³ plaques injection moulded in line with EN ISO 1873-2.

### Materials

PP1 is a propylene homopolymer produced by using a ZNC having a MFR₂ (2.16 kg, 230° C.) of 75 g/10 min and a density of 0.905 g/cm. PP1 was prepared as is disclosed in WO2015/082379, table 1 on page 37 for the inventive example IE.

PP2 is a SSC based polypropylene homopolymer with a Tm of 155° C., a content of 2,1 and 3,1 regio-defects of 0.6 mol % and MFR₂ (2.16 kg, 230° C.) of 103 g110 min. More details regarding polymerization of PP2 are given further below.

I-MARV P-140 is a hydrocarbon resin commercially available from Idemitsu Chemicals Europe Plc., Germany.

NX8000 is a nonitol based nucleating agents, for instance 1,2,3-trideoxy-4,6:5,7-bis-O-((4-propylphenyl) methylene) nonitol and commercially available from Milliken (CAS-No. 882073-43-0, Millad NX8000).

### Polymerization of PP2

### Catalyst

### Catalyst Complex

The following metallocene complex has been used as described in WO 2019/179959:

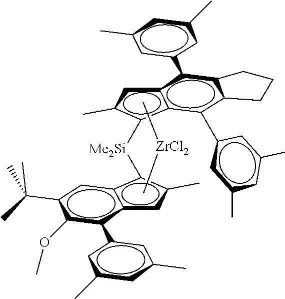

### Preparation of MAO-Silica Support

A steel reactor equipped with a mechanical stirrer and a filter net was flushed with nitrogen and the reactor temperature was set to 20° C. Next silica grade DM-L-303 from AGC Si-Tech Co, pre-calcined at 600° C. (5.0 kg) was added from a feeding drum followed by careful pressuring and depressurising with nitrogen using manual valves. Then toluene (22 kg) was added. The mixture was stirred for 15 min. Next 30 wt. % solution of MAO in toluene (9.0 kg) from Lanxess was added via feed line on the top of the reactor within 70 min. The reaction mixture was then heated up to 90° C. and stirred at 90° C. for additional two hours. The slurry was allowed to settle and the mother liquor was filtered off. The catalyst was washed twice with toluene (22 kg) at 90° C., following by settling and filtration. The reactor was cooled off to 60° C. and the solid was washed with heptane (22.2 kg). Finally MAO treated SiO₂ was dried at 60° C. under nitrogen flow for 2 hours and then for 5 hours under vacuum (−0.5 barg) with stirring. MAO treated support was collected as a free-flowing white powder found to contain 12.2% Al by weight.

### Single Site Catalyst System 1 (SSCS1) Preparation

30 wt. % MAO in toluene (0.7 kg) was added into a steel nitrogen blanked reactor via a burette at 20° C. Toluene (5.4 kg) was then added under stirring. The metallocene complex as described above under 2a) (93 g) was added from a metal cylinder followed by flushing with 1 kg toluene. The mixture was stirred for 60 minutes at 20° C. Trityl tetrakis(pentafluorophenyl) borate (91 g) was then added from a metal cylinder followed by a flush with 1 kg of toluene. The mixture was stirred for 1 h at room temperature. The resulting solution was added to a stirred cake of MAO-silica support prepared as described above over 1 hour. The cake was allowed to stay for 12 hours, followed by drying under N₂ flow at 60° C. for 2 h and additionally for 5 h under vacuum (−0.5 barg) under stirring.

Dried catalyst was sampled in the form of pink free flowing powder containing 13.9% Al and 0.11% Zr.

### Polymerization Conditions of PP2

TABLE 1

| | Unit | PP2 |
|---|---|---|
| Catalyst system | | SSCS1 |
| Prepolymerization | | |
| Temperature | ° C. | 20 |
| Pressure | kPa | 5398 |
| Catalyst feed | g/h | 2.5 |
| C3 feed | kg/h | 48 |
| H2 feed | g/h | 0.2 |
| Residence time | h | 0.38 |
| Loop (Reactor 1) | | |
| Temperature | ° C. | 75 |
| Pressure | kPa | 5359 |
| H2/C3 ratio | mol/kmol | 0.16 |
| Residence time | h | 0.48 |
| Loop reactor split | wt. % | 60 |
| MFR₂ | g/10 min | 66 |
| GPR (Reactor 2) | | |
| Temperature | ° C. | 80 |
| Pressure | kPa | 2400 |
| H2/C3 ratio | mol/kmol | 3.6 |
| Polymer residence time | h | 2.2 |
| GPR reactor split | wt. % | 40 |

### Properties of PP2

TABLE 2

| Properties | Unit | PP2 |
|---|---|---|
| Tm | ° C. | 154 |
| MWD | — | 3.2 |
| XCS | wt. % | 0.4 |
| MFR₂ | g/10 min | 103 |
| <2, 1> defects | mol % | 0.60 |

Table 3 shows the components and properties of Inventive Examples 1-6 and Comparative Examples 1-3. In the Comparative Examples no hydrocarbon resin was added.

As can be derived from Table 3, the inventive examples show a high stiffness in comparison to the comparative examples. In addition to that, the relation between the tensile modulus and haze is also improved when comparing the inventive examples with the comparative examples. Besides, the inventive examples also show an advantageous processability.

TABLE 3

| Component | Unit | IE1 | IE2 | IE3 | IE4 | IE5 | IE6 | CE1 | CE2 | CE3 |
|---|---|---|---|---|---|---|---|---|---|---|
| PP1 | wt. % | 93 | 85 | | | | | 100 | | |
| PP2 | wt. % | | | 75 | 85 | 93 | 92.6 | | 99.6 | 100 |
| I-MARV P-140 | wt. % | 7 | 15 | 25 | 15 | 7 | 7 | | | |
| Nucleating agent | wt. % | | | | | | 0.4 | | 0.4 | |
| (NX8000) | | | | | | | | | | |
| Properties | | | | | | | | | | |
| MFR₂ | g/10 min | 72 | 108 | 216 | 122 | 104 | 115 | 75 | 84 | 103 |
| Tensile modulus | MPa | 1795 | 2074 | 2259 | 2027 | 1785 | 2247 | 1491 | 2046 | 1564 |
| Tensile strength | MPa | 35.2 | 35.7 | 28.5 | 33.9 | 35.8 | 38.9 | 32.9 | 39.9 | 34.7 |
| Elongation | % | 6.6 | 2.0 | 1.2 | 1.9 | 4.9 | 3.1 | 28.1 | 34.3 | 17.8 |
| at break | | | | | | | | | | |
| Haze | % | 61.73 | 65.3 | n.a. | 56 | 65 | 6.25 | 66 | 6.36 | 66 |
| Tc | ° C. | 112 | 111 | 110 | 111 | 112 | 129 | 116 | 130 | 114 |
| Tm | ° C. | 159 | 161 | 151 | 153 | 154 | 157 | 162 | 158 | 155 |
| Hm | J/g | 95 | 97 | 81 | 90 | 98 | 105 | 113 | 109 | 105 |
| TM/Haze | MPa/% | 29.1 | 31.8 | — | 36.2 | 27.5 | 359.5 | 22.6 | 321.7 | 23.7 |

1. A polymer composition comprising
a propylene homopolymer (A) in an amount of 70 to 99 wt. % based on the total amount of the polymer composition, wherein the polypropylene homopolymer (A) has
a melt flow rate, MFR₂ (230° C./2.16 kg), as measured according to ISO 1133, in the range of 30 to 250 g/10 min,
a content of 2,1 and 3,1 regio-defects in the range of 0.0 to 1.0 mol % as measured by ¹³C NMR,
a pentad isotacticity (mmmm) in the range of 90.0 to 99.9% as measured by ¹³C NMR, and
a molecular weight distribution, MWD, in the range of 2.0 to 15.0; and
a hydrocarbon resin (B) in an amount of from 1 to 30 wt. % based on the total amount of the polymer composition;
wherein the polymer composition has a melt flow rate, MFR₂ (230° C./2.16 kg), as measured according to ISO 1133, in the range of 30 to 250 g/10 min.

2. The polymer composition according to claim 1, wherein the polypropylene homopolymer (A) has
a melting temperature, Tₘ, in the range of 150 to 170° C.; and/or
a content of 2,1 and 3,1 regio-defects in the range of 0.1 to 0.9 mol %, as measured by ¹³C NMR; and/or
a molecular weight distribution, MWD, in the range of 3.0 to 7.5.

3. The polymer composition according to claim 1,
wherein the hydrocarbon resin (B) has an average molecular weight, Mn, in the range of 600 to 1000 g/mol; and/or
a density, as measured according to JIS K0061, in the range of 1.01 to 1.07 g/cm3 (at 20° C.); and/or
wherein the hydrocarbon resin (B) is a at least partially hydrogenated petroleum resin.

4. The polymer composition according to claim 1,
wherein the propylene homopolymer (A) is present in an amount of 73 to 99 wt. %, based on the total amount of the composition; and/or
wherein the hydrocarbon resin (B) is present in an amount of 1 to 27 wt. %, based on the total amount of the composition.

5. The polymer composition according to claim 1, wherein the polymer composition has
a tensile modulus, measured according to ISO 527-2 (cross head speed=1 mm/min; 23° C.) using injection moulded specimens as described in EN ISO 1873-2 (dog bone shape, 4 mm thickness), in the range of 1500 to 3000 MPa; and/or
an elongation at break, measured according to ISO 527-2 (cross head speed=1 mm/min; 23° C.) using injection moulded specimens as described in EN ISO 1873-2 (dog bone shape, 4 mm thickness), of 15% or less.

6. The polymer composition according to claim 1, wherein the polymer composition has
a tensile strength, measured according to ISO 527-2 (cross head speed=1 mm/min; 23° C.) using injection moulded specimens as described in EN ISO 1873-2 (dog bone shape, 4 mm thickness), in the range of 25 to 45 MPa; and/or
a Haze (1 mm) when measured on 1 mm plaques of 65% or below.

7. The polymer composition according to claim 1,
wherein the polypropylene homopolymer (A) is produced in the presence of a single site catalyst (SSC), wherein the polypropylene homopolymer (A) has
a melt flow rate, MFR₂ (230° C./2.16 kg), as measured according to ISO 1133, in the range of 40 to 200 g/10 min, and/or
a content of 2,1 and 3,1 regio-defects in the range of 0.1 to 0.9 mol %, as measured by ¹³C NMR, and/or
a pentad isotacticity (mmmm) in the range of 98.0 to 99.8% as measured by ¹³C NMR, and/or
a molecular weight distribution, MWD, in the range of 2.5 to 4.0, and/or
a melting temperature, Tₘ, in the range of 152 to 156° C.

8. The polymer composition according to claim 1,
wherein the polymer composition comprises a nucleating agent (C).

9. The polymer composition according to claim 8,
wherein the polymer composition has a ratio Tensile Modulus to Haze (1 mm) when measured on 1 mm plaques of at least 325 MPa/%.

10. A process for producing a polymer composition according to claim 1, wherein the propylene homopolymer has been obtained by polymerizing propylene in the presence of a single site catalyst (SSC).

11. Use of the polymer composition according to claim 1 for injection moulding.

12. Use of the polymer composition according to claim 1 for producing packaging articles.

13. An article produced from the polymer composition according to claim 1.

14. The article according to claim 13, wherein the article is used for packaging.

15. The article according to claim 13, wherein the article has a wall thickness in the range of 0.1 to 2.5 mm.

16. The polymer composition according to claim 3,
wherein the hydrocarbon resin (B) has an average molecular weight, Mn, of 800 to 950 g/mol; and/or
a density as measured according to JIS K0061, in the range of 1.03 to 1.05 g/cm³ (at 20° C.)

17. The polymer composition according to claim 4,
wherein the propylene homopolymer (A) is present in an amount of 90 to 97.5 wt. %, based on the total amount of the composition; and/or
wherein the hydrocarbon resin (B) is present in an amount of 2.5 to 10 wt. %, based on the total amount of the composition.

18. The polymer composition according to claim 5, wherein the polymer composition has
a tensile modulus, measured according to ISO 527-2 (cross head speed=1 mm/min; 23° C.) using injection moulded specimens as described in EN ISO 1873-2 (dog bone shape, 4 mm thickness), in the range of 1700 to 2400 MPa; and/or
an elongation at break, measured according to ISO 527-2 (cross head speed=1 mm/min; 23° C.) using injection moulded specimens as described in EN ISO 1873-2 (dog bone shape, 4 mm thickness), of 0.5 to 8%.

19. The polymer composition according to claim 6, wherein the polymer composition has
a tensile strength, measured according to ISO 527-2 (cross head speed=1 mm/min; 23° C.) using injection moulded specimens as described in EN ISO 1873-2 (dog bone shape, 4 mm thickness), in the range of 28 to 40 MPa; and/or
a Haze (1 mm) when measured on 1 mm plaques of 5 to 65%.

20. The polymer composition according to claim 8, wherein the nucleating agent (C) is present in an amount of 0.00001 to 1 wt. %, based on the total weight of the polymer composition.
